(19) United States
(12) Patent Application Publication
(10) Pub. No.: US 2008/0169902 A1
(43) Pub. Date: Jul. 17, 2008

(54) Television receiver

(75) Inventor: Fumie Shiroyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/984,681

(22) Filed: Nov. 20, 2007

(30) Foreign Application Priority Data
Jan. 11, 2007 (JP) 2007-003420

(51) Int. Cl. G05B 19/00

(52) U.S. Cl. 340/5.83; 348/552; 382/124

(57) ABSTRACT

A television receiver that is equipped with a lock function for preventing the settings for the channel the user is currently viewing from being changed when a child presses an operation button such as a power button, a channel changing button, a volume setting button, etc., and that enables only a specific user to effect switching between locked and unlocked states. More specifically, the television receiver has a locked state in which the operation of any operation button provided on a receiver main unit is disabled, and an unlocked state in which the operation is enabled, and the television receiver is constructed to include: a storage unit which stores fingerprint data of an authorized user; a fingerprint authentication unit which compares fingerprint data acquired by scanning a finger of a user with the fingerprint data stored in the storage unit, and thereby identifies whether the user is an authorized user or not; and a control unit which effects switching between the locked state and the unlocked state each time the user is identified as an authorized user by the fingerprint authentication unit.

### BACKGROUND OF THE INVENTION

1. Field of the Invention

The present invention relates to a television receiver equipped with a lock function that disables the operation of an operation button.

2. Description of the Related Art

Television receivers equipped with a child lock function for preventing the receiver power from being turned by a remote control have been around for many years. For example, Japanese Unexamined Patent Publication No. H07-23307 discloses a television receiver that can indicate a child lock ON state by flashing an LED or by producing a sound for a predetermined length of time or by a combination thereof without causing a degradation of screen quality or an increase in power consumption and without having to provide a dedicated LED for indicating a child lock ON state.

On the other hand, Japanese Unexamined Patent Publication No. 2004-77990 discloses an image forming apparatus that incorporates a fingerprint authentication mechanism in a sleep button or a power switch, with provisions made to perform user authentication each time the button or switch is pressed and to call up at the same time a user customized function or screen or the like, thus enhancing security without compromising usability by combining the fingerprint authentication mechanism with a sleep button, etc.

In many television receivers, the power button, channel changing button, volume button, etc., are on the front of the television receiver main unit and are therefore within the reach of a young child. Accordingly, there a problem arises that a child may press the power button to turn off the power or may change channels or the power volume setting while playing with the television receiver. If the main power switch on the receiver unit is turned off, the remote controller for the television receiver can no longer be operated.

### SUMMARY OF THE INVENTION

In view of the above problem, it is an object of the present invention to provide a television receiver that is equipped with a lock function for preventing the settings for the channel the user is currently viewing from being changed when a child presses an operation button such as a power button, a channel changing button, a volume setting button, etc., mounted on the receiver main unit, and that enables only a specific user to switch between locked and unlocked states.

To achieve the above object, according to one aspect of the present invention, there is provided a television receiver having a locked state in which the operation of any operation button provided on a receiver main unit is disabled, and an unlocked state in which the operation is enabled, comprising: a storage unit which stores fingerprint data of an authorized user; a fingerprint authentication unit which compares fingerprint data acquired by scanning a finger of a user with fingerprint data stored in the storage unit, and thereby identifying whether the user is an authorized user or not; and a control unit which switches between the locked state and unlocked state each time the user is identified as an authorized user by the fingerprint authentication unit.

In one preferred mode, fingerprint data of more than one user can be stored in the storage unit.

In another preferred mode, the television receiver further comprises a unit that stores the fingerprint data of the user in the storage unit.

In another preferred mode, the television receiver further comprises a unit that clears fingerprint data stored in the storage unit.

In one preferred mode, the television receiver further comprises a unit that indicates whether the television receiver is in the locked state or unlocked state.

According to the present invention, there are also provided: a recording medium having a program recorded thereon for causing a computer incorporated in the television receiver to implement the above-described functions; and a method for use in the television receiver.

According to the television receiver of the present invention, since switching is effected between the locked state and unlocked state each time the user is identified as an authorized user by fingerprint authentication, the authorized user can change the state through a simple operation. In the locked state, if a child operates the power button, channel changing button, volume setting button, etc., the operation is not completed which contributes to preventing an erroneous operation. This also serves to free the user from turning the power on again or readjusting the volume setting, etc.

### BRIEF DESCRIPTION OF THE DRAWINGS

The further features and advantages of the present invention will be apparent from the following description with reference to the accompanying drawings, in which:

FIG. 1 is a diagram showing the external appearance of a television receiver according to one embodiment of the present invention;

FIG. 2 is a block diagram showing the configuration of a lock device implemented as a computer system within the television receiver shown in FIG. 1;

FIG. 3 is a flowchart showing a processing procedure for a main routine that is executed after power is turned on;

FIG. 4 is a flowchart showing a processing procedure for an additional fingerprint registration routine that is executed when an additional fingerprint registration button is depressed; and

FIG. 5 is a flowchart showing a processing procedure for a fingerprint registration clear routine that is executed when a fingerprint registration clear button is depressed.

### DESCRIPTION OF THE PREFERRED EMBODIMENTS

An embodiment of the present invention will be described below with reference to the accompanying drawings.

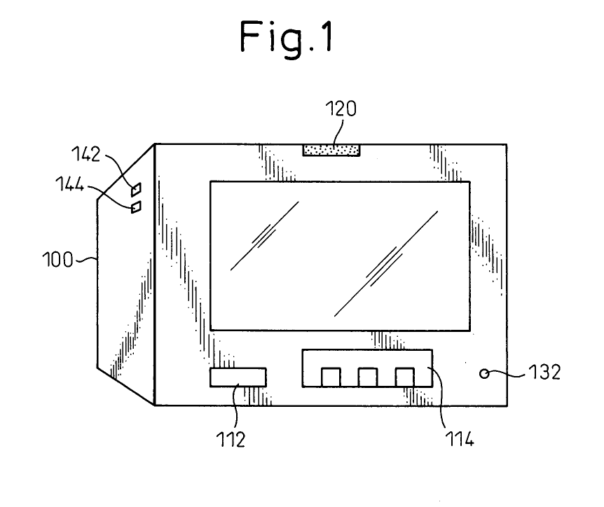

FIG. 1 is a diagram showing the external appearance of a television receiver according to one embodiment of the present invention. In the figure, reference numeral 100 is a television receiver main unit, 112 is a power button, 114 is a group of setting buttons including a channel button and a volume button, 120 is a fingerprint authentication device incorporated in the receiver main unit 100, 132 is a lock state indicating lamp, 142 is an additional fingerprint registration button, and 144 is a fingerprint registration clear button.

The television receiver shown in FIG. 1 has a locked state in which operation of power button 112 as well as operation of channel, volume, and other setting buttons 114 is disabled, and an unlocked state in which the operation of these buttons is enabled. When the receiver is in the locked state, lock state indicating lamp 132 is illuminated. Additional fingerprint registration button 142 and fingerprint registration clear button 144 are concealed behind a cover plate on one side of receiver main unit 100.

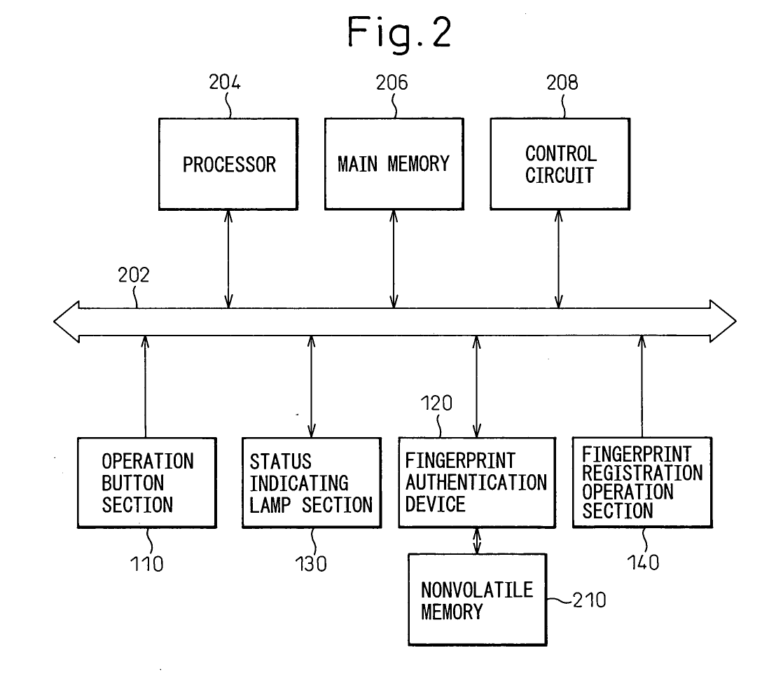

FIG. 2 is a block diagram showing the configuration of a lock device implemented as a computer system within the television receiver shown in FIG. 1. In the figure, reference numeral 110 indicates an operation button section comprising power button 112, channel, volume, and other setting buttons 114, etc. Reference numeral 130 indicates a status indicating lamp section comprising the lock state indicating lamp 132, etc. Reference numeral 140 indicates a fingerprint registration operation section comprising additional fingerprint registration button 142 and fingerprint registration clear button 144.

Further, reference numerals 202, 204, and 206 indicate a bus, a processor, and a main memory, respectively. Reference numeral 208 indicates a control circuit which controls power off, channel changing, etc. Reference numeral 210 indicates a nonvolatile memory, connected to the fingerprint authentication device, for storing authorized users' fingerprint data.

The processor 204 implements the lock control according to the present invention by executing a program loaded into the main memory 206. The detailed procedure will be described below.

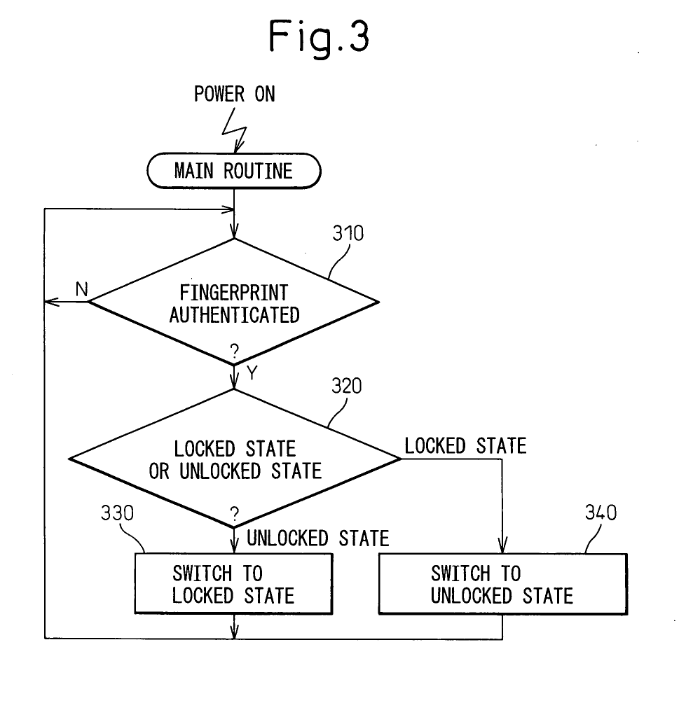

FIG. 3 is a flowchart showing the processing procedure for the main routine that is executed after power is turned on. Here, since power can be turned off by depressing the power button 112 only when the television receiver is in the unlocked state, the receiver is always in the unlocked state when turning on power by depressing the power button 112.

After powering on, the main routine waits until an authorized user is authenticated by the fingerprint authentication device 120 (step 310). The fingerprint authentication by the fingerprint authentication device 120 is accomplished by acquiring fingerprint data from the user's finger held over the device and by comparing the acquired fingerprint data against the registered fingerprint data stored in the nonvolatile memory 210. The nonvolatile memory 210 can store fingerprint data for a plurality of registered users, and when the acquired fingerprint data matches the fingerprint data of one of the registered users, the user is identified as an authorized user. If there is no registered data, the fingerprint authentication is not performed, and as a result, the unlocked state is maintained.

When the fingerprint authentication is done, it is determined whether the television receiver is in the locked state or unlocked state (step 320).

When the current state is the unlocked state, the processor 204 performs control to switch the state to the locked state (step 330). When the fingerprint authentication is done for the first time after power on, such switching occurs. In the locked state, even when the power button 112 or any one of the channel, volume, and other setting buttons 114 is depressed, the processor 204 disables the corresponding signal which is therefore not sent to the control circuit 208. At the same time that the state is switched to the locked state, the processor 204 performs control to turn on the lock state indicating lamp 132.

On the other hand, when the current state is the locked state, the processor 204 performs control to switch the state to the unlocked state (step 340). In the unlocked state, when the power button 112 or any one of the channel, volume, and other setting buttons 114 is depressed, the processor 204 sends the corresponding signal to the control circuit 208. At the same time that the state is switched to the unlocked state, the processor 204 performs control to turn off the lock state indicating lamp 132.

After carrying out step 330 or 340, the processor 204 returns to step 310 to repeat the above process.

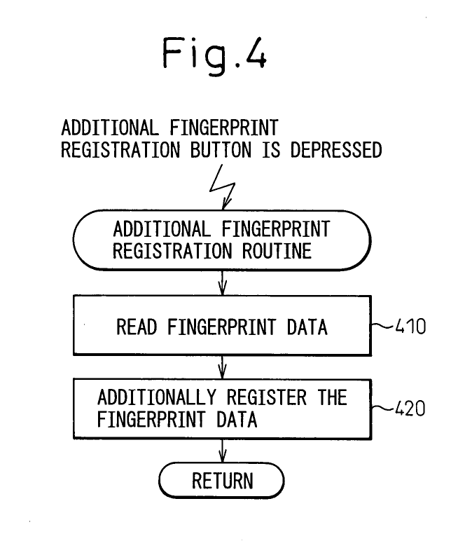

FIG. 4 is a flowchart showing a processing procedure for the additional fingerprint registration routine that is executed when the additional fingerprint registration button 142 is depressed. When the additional fingerprint registration button 142 is depressed, the processor 204 controls the fingerprint authentication device 120 so as to read fingerprint data when the user holds his or her finger over the device (step 410). If the processor fails to read fingerprint data within a predefined time, the processing is terminated.

Next, the processor 204 controls the fingerprint authentication device 120 so as to additionally register the thus read fingerprint data with the nonvolatile memory 210 (step 420). If there is no previously registered data, the current registration is the first registration. After the registration is done, the process being performed by the processor 204 returns to the main routine.

In this way, lock function can be achieved that prevents, for example, children from operating any operation buttons, but allows their parents to operate the buttons.

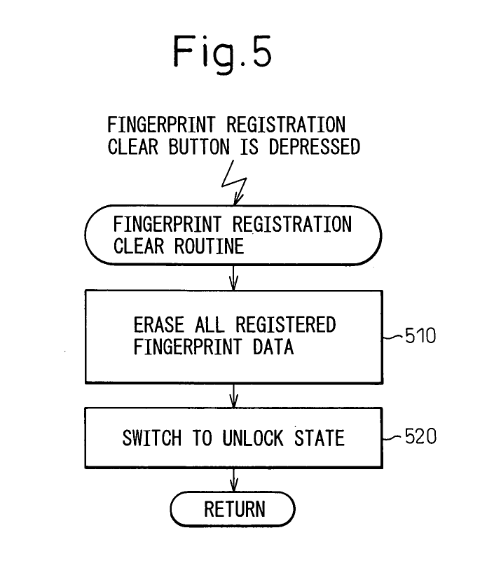

FIG. 5 is a flowchart showing a processing procedure for the fingerprint registration clear routine that is executed when the fingerprint registration clear button 144 is depressed. When the fingerprint registration clear button 144 is depressed, the processor 204 controls the fingerprint authentication device 120 so as to erase all the registered fingerprint data stored in the nonvolatile memory 210 (step 510).

Next, the processor 204 performs control to switch the state to the unlocked state in case the television receiver is in the locked state (step 520). The reason is that, if the fingerprint data were erased with the television receiver in the locked state, the lock could not be unlocked. At the same time that the state is switched to the unlocked state, the processor 204 performs control to turn off the lock state indicating lamp 132. After that, the process being performed by the processor 204 returns to the main routine.

Here, provisions may be made to display a prescribed menu on the screen of the television receiver so that the additional registration of fingerprint data or clearing of the registered fingerprint data can be performed on the screen.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A television receiver having a locked state in which the operation of any operation button provided on a receiver main unit is disabled, and an unlocked state in which said operation is enabled, comprising:
a storage unit which stores fingerprint data of an authorized user;
a fingerprint authentication unit which compares fingerprint data acquired by scanning a finger of a user with the fingerprint data stored in said storage unit, and thereby identifies whether said user is an authorized user or not; and
a control unit which effects switching between said locked state and said unlocked state each time said user is identified as an authorized user by said fingerprint authentication unit.

2. A television receiver as claimed in claim 1, wherein fingerprint data of more than one user can be stored in said storage unit.

3. A television receiver as claimed in claim 1, further comprising a unit that accepts an operation for storing the fingerprint data of said user in said storage unit.

4. A television receiver as claimed in claim 1, further comprising a unit that accepts an operation for clearing the fingerprint data stored in said storage unit.

5. A television receiver as claimed in claim 1, further comprising a unit that indicates whether said television receiver is in said locked state or in said unlocked state.

6. A computer readable recording medium for use with a computer incorporated in a television receiver having a locked state in which the operation of any operation button provided on a receiver main unit is disabled, and an unlocked state in which said operation is enabled, said recording medium having a program recorded thereon for causing said computer to function as:
a storage unit which stores fingerprint data of an authorized user;
a fingerprint authentication unit which compares fingerprint data acquired by scanning a finger of a user with the fingerprint data stored in said storage unit, and thereby identifies whether said user is an authorized user or not; and
a control unit which effects switching between said locked state and said unlocked state each time said user is identified as an authorized user by said fingerprint authentication unit.

7. A recording medium as claimed in claim 6, wherein said program further causes said computer to function so as to store fingerprint data of more than one user in said storage unit.

8. A recording medium as claimed in claim 6, wherein said program further causes said computer to function as a unit that accepts an operation for storing the fingerprint data of said user in said storage unit.

9. A recording medium as claimed in claim 6, wherein said program further causes said computer to function as a unit that accepts an operation for clearing the fingerprint data stored in said storage unit.

10. A recording medium as claimed in claim 6, wherein said program further causes said computer to function as a unit that indicates whether said television receiver is in said locked state or in said unlocked state.

11. A lock control method for use in a television receiver having a locked state in which the operation of any operation button provided on a receiver main unit is disabled, and an unlocked state in which said operation is enabled, comprising:
causing a fingerprint authentication unit to compare fingerprint data acquired by scanning a finger of a user with fingerprint data prestored in a storage unit, and thereby identify whether said user is an authorized user or not; and
causing a control unit to effect switching between said locked state and said unlocked state each time said user is identified as an authorized user.

12. A method as claimed in claim 11, wherein fingerprint data of more than one user can be stored in said storage unit.

13. A method as claimed in claim 11, further comprising causing an input unit to accept an operation for storing the fingerprint data of said user.

14. A method as claimed in claim 11, further comprising causing an input unit to accept an operation for clearing said stored fingerprint data.

15. A method as claimed in claim 11, further comprising causing an output unit to indicate whether said television receiver is in said locked state or in said unlocked state.
